(19) United States
(12) Patent Application Publication
(10) Pub. No.: US 2026/0019001 A1
(43) Pub. Date: Jan. 15, 2026

(54) DUAL ACTIVE BRIDGE CIRCUIT, POWER SUPPLY, AND DC-DC CONVERTER

(71) Applicant: Shenzhen Winline Technology Co., Ltd., Shenzhen (CN)

(72) Inventors: Yisai WU, Shenzhen (CN); Xiaoping CHEN, Shenzhen (CN); Haidong ZHANG, Shenzhen (CN); Yanghao CHEN, Shenzhen (CN); Kaixuan ZHANG, Shenzhen (CN); Jianguo ZHU, Shenzhen (CN)

(73) Assignee: Shenzhen Winline Technology Co., Ltd., Shenzhen (CN)

(21) Appl. No.: 19/334,257

(22) Filed: Sep. 19, 2025

Related U.S. Application Data
(63) Continuation of application No. PCT/CN2024/097245, filed on Jun. 4, 2024.

(30) Foreign Application Priority Data
Jun. 9, 2023 (CN) 202310680564.3

(51) Int. Cl. H02M 3/335

(52) U.S. Cl. CPC H02M 3/33573; H02M 3/33576

(57) ABSTRACT

A dual active bridge (DAB) circuit, a power supply, and a direct current to direct current (DC-DC) converter are provided. The DAB circuit includes a primary-side DC power supply, a primary-side single-phase full-bridge circuit, a transformer module, a secondary-side single-phase full-bridge circuit, and a secondary-side DC load connected in sequence. The first switching unit is configured to switch a turns ratio of the transformer according to the input voltage and the output voltage. The inductor unit is configured to provide a corresponding inductance when the first switching unit switches the turns ratio, to adjust power conversion efficiency of the primary-side single-phase full-bridge circuit and/or the secondary-side single-phase full-bridge circuit. The DC-blocking unit is configured to isolate a DC voltage on a secondary side of the transformer and output an alternating current (AC) voltage on the secondary side of the transformer to the secondary-side single-phase full-bridge circuit.

This application is a continuation under 35 U.S.C. § 120 of International Patent Application No. PCT/CN2024/097245, filed Jun. 4, 2024, which claims priority under 35 U.S.C. § 119 (a) and/or PCT Article 8 to Chinese Patent Application No. 202310680564.3, filed Jun. 9, 2023, the entire disclosures of both of which are incorporated herein by reference.

### TECHNICAL FIELD

The disclosure relates to the field of direct current to direct current (DC-DC) conversion, and in particular, to a dual active bridge (DAB) circuit, a power supply, and a DC-DC converter.

### BACKGROUND

Currently, with the rapid development of the new energy industry and novel batteries in recent years, the demand for bidirectional flow of electrical energy has gradually begun to replace the demand for traditional unidirectional flow of electrical energy. In isolated bidirectional topologies, a dual active bridge (DAB) topology has advantages such as a wide voltage gain conversion ratio, high power density, input-output electrical isolation, and high conversion efficiency, showing significant development potential in battery charging/discharging and other fields requiring bidirectional energy flow.

### SUMMARY

In a first aspect, a dual active bridge (DAB) circuit is provided in the disclosure. The DAB circuit includes a primary-side direct current (DC) power supply, a primary-side single-phase full-bridge circuit, a transformer module, a secondary-side single-phase full-bridge circuit, and a secondary-side DC load connected in sequence. The transformer module includes a transformer, a first switching unit, an inductor unit, and a DC-blocking unit. The transformer is configured to perform voltage conversion on an input voltage input by the primary-side DC power supply and obtained through the primary-side single-phase full-bridge circuit, to obtain an output voltage. The first switching unit is configured to switch a turns ratio of the transformer according to the input voltage and the output voltage. The inductor unit is configured to provide a corresponding inductance when the first switching unit switches the turns ratio, to adjust power conversion efficiency of the primary-side single-phase full-bridge circuit and/or the secondary-side single-phase full-bridge circuit. The DC-blocking unit is configured to isolate a DC voltage on a secondary side of the transformer and output an alternating current (AC) voltage on the secondary side of the transformer to the secondary-side single-phase full-bridge circuit. The inductor unit includes a first inductor, a second inductor, a third inductor, and a fourth inductor. A first terminal of the first inductor is connected to the first switching unit, and a second terminal of the first inductor is connected to a first terminal of a primary side of the transformer. A first terminal of the second inductor is connected to the first switching unit, and a second terminal of the second inductor is connected to a second terminal of the primary side of the transformer. A first terminal of the third inductor is connected to the first switching unit, and a second terminal of the third inductor is connected to a first terminal of the secondary side of the transformer. A first terminal of the fourth inductor is connected to the first switching unit, and a second terminal of the fourth inductor is connected to a second terminal of the secondary side of the transformer. A third terminal of the primary side of the transformer is connected to the primary-side single-phase full-bridge circuit, and a third terminal of the secondary side of the transformer is connected to the secondary-side single-phase full-bridge circuit. The first inductor has an inductance greater than the second inductor, and the third inductor has an inductance greater than the fourth inductor. When both the input voltage and the output voltage are high voltages, the first switching unit is configured to be connected to the first inductor and the third inductor, and disconnected from the second inductor and the fourth inductor, to adjust a total inductance of the inductor unit to a first inductance. When the input voltage is a high voltage and the output voltage is a low voltage, the first switching unit is configured to be connected to the first inductor and the fourth inductor, and disconnected from the second inductor and the third inductor, to adjust the total inductance of the inductor unit to a second inductance; or when the input voltage is a low voltage and the output voltage is a high voltage, the first switching unit is configured to be connected to the second inductor and the third inductor, and disconnected from the first inductor and the fourth inductor, to adjust the total inductance of the inductor unit to the second inductance. When both the input voltage and the output voltage are low voltages, the first switching unit is configured to be connected to the second inductor and the fourth inductor, and disconnected from the first inductor and the third inductor, to adjust the total inductance of the inductor unit to a third inductance. The first inductance is greater than the second inductance, and the second inductance is greater than the third inductance.

In a second aspect, a DAB circuit is provided in the disclosure. The DAB circuit includes a primary-side DC power supply, a primary-side single-phase full-bridge circuit, a transformer module, a secondary-side single-phase full-bridge circuit, and a secondary-side DC load connected in sequence. The transformer module includes a transformer, a first switching unit, an inductor unit, and a DC-blocking unit. The transformer is configured to perform voltage conversion on an input voltage input by the primary-side DC power supply and obtained through the primary-side single-phase full-bridge circuit, to obtain an output voltage. The first switching unit is configured to switch a turns ratio of the transformer according to the input voltage and the output voltage. The inductor unit is configured to provide a corresponding inductance when the first switching unit switches the turns ratio, to adjust power conversion efficiency of the primary-side single-phase full-bridge circuit and/or the secondary-side single-phase full-bridge circuit. The DC-blocking unit is configured to isolate a DC voltage on a secondary side of the transformer and output an AC voltage on the secondary side of the transformer to the secondary-side single-phase full-bridge circuit. The inductor unit includes a first inductor, a second inductor, a third inductor, a fourth inductor, a fifth inductor, and a sixth inductor. A first terminal of the first inductor is connected to the first switching unit, and a second terminal of the first inductor is connected to a first terminal of a primary side of the transformer. A first terminal of the second inductor is connected to the first switching unit, and a second terminal of the second inductor is connected to a second terminal of the primary side of the transformer. A first terminal of the third inductor is connected to the first switching unit, and a second terminal of the third inductor is connected to a first terminal of the secondary side of the transformer. A first terminal of the fourth inductor is connected to the first switching unit, and a second terminal of the fourth inductor is connected to a second terminal of the secondary side of the transformer. A first terminal of the fifth inductor is connected to the primary-side single-phase full-bridge circuit, and a second terminal of the fifth inductor is connected to the DC-blocking unit. A first terminal of the sixth inductor is connected to the first switching unit, and a second terminal of the sixth inductor is connected to the secondary-side single-phase full-bridge circuit. A third terminal of the primary side of the transformer is connected to the primary-side single-phase full-bridge circuit, and a third terminal of the secondary side of the transformer is connected to the first switching unit. The first inductor has an inductance greater than the second inductor, and the third inductor has an inductance greater than the fourth inductor. When both the input voltage and the output voltage are high voltages, the first switching unit is configured to be connected to the first inductor, the third inductor, the fifth inductor, and the sixth inductor, and disconnected from the second inductor and the fourth inductor, to adjust a total inductance of the inductor unit to a first inductance. When the input voltage is a high voltage and the output voltage is a low voltage, the first switching unit is configured to be connected to the first inductor, the fourth inductor, the fifth inductor, and the sixth inductor, and disconnected from the second inductor and the third inductor, to adjust the total inductance of the inductor unit to a second inductance; or when the input voltage is a low voltage and the output voltage is a high voltage, the first switching unit is configured to be connected to the second inductor, the third inductor, the fifth inductor, and the sixth inductor, and disconnected from the first inductor and the fourth inductor, to adjust the total inductance of the inductor unit to the second inductance. When both the input voltage and the output voltage are low voltages, the first switching unit is configured to be connected to the second inductor, the fourth inductor, the fifth inductor, and the sixth inductor, and disconnected from the first inductor and the third inductor, to adjust the total inductance of the inductor unit to a third inductance. The first inductance is greater than the second inductance, and the second inductance is greater than the third inductance.

In a third aspect, a DAB circuit is provided in the disclosure. The DAB circuit includes a primary-side DC power supply, a primary-side single-phase full-bridge circuit, a transformer module, a secondary-side single-phase full-bridge circuit, and a secondary-side DC load connected in sequence. The transformer module includes a transformer, a first switching unit, an inductor unit, and a DC-blocking unit. The transformer is configured to perform voltage conversion on an input voltage input by the primary-side DC power supply and obtained through the primary-side single-phase full-bridge circuit, to obtain an output voltage. The first switching unit is configured to switch a turns ratio of the transformer according to the input voltage and the output voltage. The inductor unit is configured to provide a corresponding inductance when the first switching unit switches the turns ratio, to adjust power conversion efficiency of the primary-side single-phase full-bridge circuit and/or the secondary-side single-phase full-bridge circuit. The DC-blocking unit is configured to isolate a DC voltage on a secondary side of the transformer and output an AC voltage on the secondary side of the transformer to the secondary-side single-phase full-bridge circuit. The inductor unit includes a first inductor, a second inductor, and a third inductor. A first terminal of the first inductor is connected to the primary-side single-phase full-bridge circuit, and a second terminal of the first inductor is connected to the DC-blocking unit. A first terminal of the second inductor is connected to the first switching unit, and a second terminal of the second inductor is connected to a first terminal of a primary side of the transformer. A first terminal of the third inductor is connected to the first switching unit, and a second terminal of the third inductor is connected to a first terminal of the secondary side of the transformer. A second terminal f of the primary side of the transformer is connected to the first switching unit, and a third terminal of the primary side of the transformer is connected to the primary-side single-phase full-bridge circuit. A second terminal of the secondary side of the transformer is connected to the first switching unit, and a third terminal of the secondary side of the transformer is connected to the secondary-side single-phase full-bridge circuit. When both the input voltage and the output voltage are high voltages, the first switching unit is configured to be connected to the first inductor, the second inductor, and the third inductor, to adjust a total inductance of the inductor unit to a first inductance. When the input voltage is a high voltage and the output voltage is a low voltage, the first switching unit is configured to be connected to the first inductor and the second inductor and disconnected from the third inductor, to adjust the total inductance of the inductor unit to a second inductance; or when the input voltage is a low voltage and the output voltage is a high voltage, the first switching unit is configured to be connected to the first inductor and the third inductor and disconnected from the second inductor, to adjust the total inductance of the inductor unit to the second inductance. When both the input voltage and the output voltage are low voltages, the first switching unit is configured to be connected to the first inductor and disconnected from the second inductor and the third inductor, to adjust the total inductance of the inductor unit to a third inductance. The first inductance is greater than the second inductance, and the second inductance is greater than the third inductance.

### BRIEF DESCRIPTION OF THE DRAWINGS

In order to describe technical solutions of embodiments of the disclosure more clearly, the following will give a brief introduction to the accompanying drawings used for describing the embodiments. Apparently, the accompanying drawings hereinafter described are some embodiments of the disclosure. Based on these drawings, those of ordinary skill in the art can also obtain other drawings without creative effort.

FIG. 1 is a schematic structural diagram of a dual active bridge (DAB) circuit provided in an embodiment of the disclosure.

FIG. 2 is a schematic diagram of a DAB circuit of an embodiment provided in the disclosure.

FIG. 3 is a schematic diagram of a DAB circuit of an embodiment provided in the disclosure.

FIG. 4 is a schematic diagram of a DAB circuit of an embodiment provided in the disclosure.

FIG. 5 is a schematic diagram of a DAB circuit of an embodiment provided in the disclosure.

FIG. 6 is a schematic diagram of a DAB circuit of an embodiment provided in the disclosure.

FIG. 7 is a block diagram of a power supply provided in an embodiment of the disclosure.

FIG. 8 is a block diagram of a direct current to direct current (DC-DC) converter provided in an embodiment of the disclosure.

### DETAILED DESCRIPTION

In order for those of ordinary skill in the art to better understand the disclosure, technical solutions in embodiments of the disclosure will be described clearly and completely hereinafter with reference to the accompanying drawings. Apparently, the described embodiments are merely some embodiments rather than all embodiments of the disclosure. Based on the embodiments of the disclosure, all other embodiments obtained by those of ordinary skill in the art based on the embodiments of the disclosure without creative efforts shall fall within the protection scope of the disclosure.

The terms “first”, “second”, and the like used in the specification, the claims, and the accompany drawings of the disclosure are used to distinguish different objects rather than describe a particular order. The terms “include” and “comprise” as well as variations thereof are intended to cover non-exclusive inclusion. For example, a process, a method, a system, a product, or an apparatus including a series of operations or units is not limited to the listed operations or units, on the contrary, it can optionally include other operations or units that are not listed; alternatively, other operations or units inherent to the process, method, product, or device can be included either.

The term “embodiment” referred to herein means that a particular feature, structure, or feature described in conjunction with the embodiment may be contained in at least one embodiment of the disclosure. The term embodiment as used herein does not necessarily refer to the same embodiment, nor does it refer to an independent or alternative embodiment that is mutually exclusive with other embodiments. It is expressly and implicitly understood by those of ordinary skill in the art that an embodiment described herein may be combined with other embodiments.

To make the effective value of an inductor current minimum is a common control method for the DAB topology. Currently, a wide range of voltage output of the topology is achieved by switching the transformer turns ratio according to different output states. The inductance has a significant impact on both the control method for the DAB topology and the maximum inductor current under the final control effect. If the inductance is too large, it will lead to a smaller overall output capability of the topology and an excessively large effective value of the inductor current. If the inductance is too small, it is difficult to ensure zero voltage switching (ZVS) of switch transistors under high voltage. Therefore, the optimal inductance is different for different operating states. However, currently, the inductance is fixed in most designs, which ensures the wide-range output of the DAB topology at the expense of sacrificing some performance. Consequently, in the DAB circuits of the related art, the inductance remains unchanged under all operating conditions, resulting in lower electrical energy conversion efficiency of the circuit under certain operating conditions.

Related terms involved in the disclosure are introduced below.

Common modulation methods for a dual active bridge (DAB) topology include single phase shift (SPS) modulation, dual phase shift (DPS) modulation, extended phase shift (EPS) modulation, and triple phase shift (TPS) modulation. In the above modulation methods, the transmission power is controlled by controlling the relative phase shift of drive signals between bridges in a DAB converter. The TPS control includes three control variables and has higher control degree of freedom, such that the optimal solution of global control under different operating states is more easily obtained.

To solve the above problems, a DAB circuit is provided in embodiments of the disclosure. The DAB circuit includes a primary-side direct current (DC) power supply, a primary-side single-phase full-bridge circuit, a transformer module, a secondary-side single-phase full-bridge circuit, and a secondary-side DC load connected in sequence. The transformer module includes a transformer, a first switching unit, an inductor unit, and a DC-blocking unit. The DAB circuit may be applied in DC-DC conversion scenarios.

The transformer is configured to perform voltage conversion on an input voltage input by the primary-side DC power supply and obtained through the primary-side single-phase full-bridge circuit, to obtain an output voltage. The first switching unit is configured to switch a turns ratio of the transformer according to the input voltage and the output voltage. The inductor unit is configured to provide a corresponding inductance when the first switching unit switches the turns ratio, to adjust power conversion efficiency of the primary-side single-phase full-bridge circuit and/or the secondary-side single-phase full-bridge circuit. The DC-blocking unit is configured to isolate a DC voltage on a secondary side of the transformer and output an alternating current (AC) voltage on the secondary side of the transformer to the secondary-side single-phase full-bridge circuit. This solution may be applied in multiple scenarios, including but not limited to the application scenarios mentioned above.

The operating principles of the DAB circuit are analyzed below.

As illustrated in FIG. 2 to FIG. 6, the DAB circuit includes a primary-side DC power supply Vi, a primary-side single-phase full-bridge circuit, a transformer module, a secondary-side single-phase full-bridge circuit, and a secondary-side DC load Vo. Forward energy transfer is defined as energy transfer from Vi to Vo, where Vi is the input DC source voltage and Vo is the secondary-side DC load.

The primary-side single-phase full-bridge circuit includes a first filter capacitor Ci, a first switch transistor Q1, a second switch transistor Q2, a third switch transistor Q3, and a fourth switch transistor Q4. The secondary-side single-phase full-bridge circuit includes a second filter capacitor Co, and a fifth switch transistor Q5, a sixth switch transistor Q6, a seventh switch transistor Q7, and an eighth switch transistor Q8.

Specifically, forward energy transfer from an input end to a battery end is taken as an example. Under the current topology, the transformer has four primary-to-secondary turns ratios: (1) Np:Ns=e+f:i+j; (2) Np:Ns=e+f:i; (3) Np:Ns=f:i+j; (4) Np:Ns=f:j. These four turns ratios correspond to four operating states: (1) high input voltage to high output voltage; (2) high input voltage to low output voltage; (3) low input voltage to high output voltage; (4) low input voltage to low output voltage.

In the operating state of high input voltage to high output voltage, switching loss in a switch transistor is relatively high. The DAB circuit achieves zero voltage switching (ZVS) through resonance between the parasitic capacitor of the switch transistor and the inductor. A necessary condition for achieving soft switching of the switch transistor is:

$$\frac{L * {i}^{2}}{2} > \frac{C * {V}^{2}}{2} \qquad formula ( 1 )$$

L is the sum of inductance of all inductors on the primary side and the secondary side of the transformer, and i is the inductor current at the moment the switch transistor is turned off. C is the parasitic capacitance between the drain and the source of the switch transistor, and Vis the drain-to-source voltage of the switch transistor. This means that the energy stored in the inductor is greater than the energy stored in the capacitor. Under high voltage, the voltage across the parasitic capacitor of the switch transistor is higher, that is, V is higher. As known from formula (1), when other parameters are constant, a larger inductance L makes it easier to achieve ZVS of the switch transistor. A larger inductance facilitates ZVS of the switch transistor and improves the efficiency.

In the operating state of low input voltage to low output voltage state, the lower voltage across the capacitor makes ZVS of the switch transistor easier to achieve. Therefore, under low input voltage and low output voltage, the minimum inductance is less limited by the conditions for ZVS of the switch transistor. The baseline value for the maximum transmission power of the transformer in the forward energy transfer is:

$$Pbasic = \frac{{V}_{1}^{2}}{8 * L * f} \qquad formula ( 2 )$$

The maximum transmission power of the DAB topology is given by formula (2). As known from formula (2), a smaller inductance L results in a greater maximum transmission power and a stronger output capability.

In the operating state of high input voltage to low output voltage or low input voltage to high output voltage, based on the above analysis, it is more difficult to achieve soft switching on the high-voltage side. Therefore, a greater inductance is required on the high-voltage side, and the current flows through the low-voltage side becomes larger. Therefore, a smaller inductance is required on the low-voltage side.

In conclusion, in the case where the voltage is high, a greater inductance yields a higher efficiency of the topology. In the case where the voltage is low, a smaller inductance yields a higher efficiency of the topology. To meet the requirement for different inductances under different operating states, two improved topologies are proposed below.

The specific solutions are introduced in detail below.

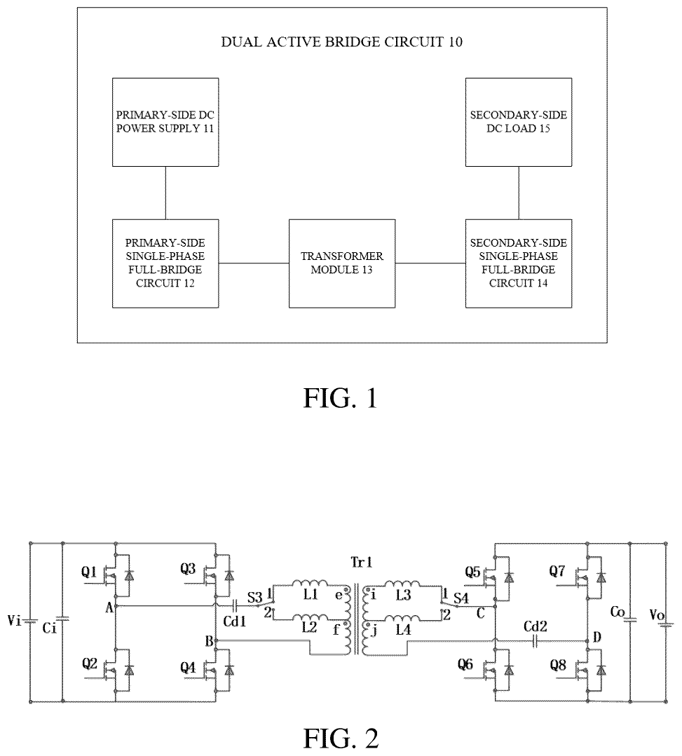

Reference is made to FIG. 1, a DAB circuit 10 is further provided in the disclosure. The DAB circuit 10 includes a primary-side DC power supply 11, a primary-side single-phase full-bridge circuit 12, a transformer module 13, a secondary-side single-phase full-bridge circuit 14, and a secondary-side DC load 15 connected in sequence. The transformer module 13 includes a transformer, a first switching unit, an inductor unit, and a DC-blocking unit. The transformer is configured to perform voltage conversion on an input voltage input by the primary-side DC power supply 11 and obtained through the primary-side single-phase full-bridge circuit 12, to obtain an output voltage. The first switching unit is configured to switch a turns ratio of the transformer according to the input voltage and the output voltage. The inductor unit is configured to provide a corresponding inductance when the first switching unit switches the turns ratio, to adjust power conversion efficiency of the primary-side single-phase full-bridge circuit 12 and/or the secondary-side single-phase full-bridge circuit 14. The DC-blocking unit is configured to isolate a DC voltage on a secondary side of the transformer and output an AC voltage on the secondary side of the transformer to the secondary-side single-phase full-bridge circuit 14.

In specific implementation, to ensure that different input/output conditions can meet the inductance requirements for efficient operation of the switch transistor, an improvement on the transformer module 13 is made in this embodiment. Specifically, the first switching unit is switched according to the input voltage and the output voltage to switch the turns ratio of the transformer, while adjusting a connected inductance of the inductor unit, so that both the primary-side single-phase full-bridge circuit 12 and the secondary-side single-phase full-bridge circuit 14 satisfy the corresponding requirements for soft switching of the switch transistors, ensuring that the DAB circuit can maintain optimal electrical energy conversion efficiency under different operating conditions.

It may be seen that, in this embodiment, the first switching unit is switched according to the input voltage and the output voltage to switch the turns ratio of the transformer, while adjusting a connected inductance of the inductor unit, so that both the primary-side single-phase full-bridge circuit 12 and the secondary-side single-phase full-bridge circuit 14 satisfy the corresponding requirements for soft switching of the switch transistors. In this way, the transformer turns ratio is switched according to different input/output states to adjust the inductance, thereby improving the control effect of the circuit switching and improving the electrical energy conversion efficiency of the DAB circuit 10 under wide-range conditions.

### Embodiment 1

In a possible embodiment, as illustrated in FIG. 2, the inductor unit includes a first inductor L1, a second inductor L2, a third inductor L3, and a fourth inductor L4. A first terminal of the first inductor L1 is connected to the first switching unit, and a second terminal of the first inductor L1 is connected to a first terminal e of a primary side of the transformer Tr1. A first terminal of the second inductor L2 is connected to the first switching unit, and a second terminal of the second inductor L2 is connected to a second terminal f of the primary side of the transformer Tr1. A first terminal of the third inductor L3 is connected to the first switching unit, and a second terminal of the third inductor L3 is connected to a first terminal i of the secondary side of the transformer Tr1. A first terminal of the fourth inductor L4 is connected to the first switching unit, and a second terminal of the fourth inductor L4 is connected to a second terminal j of the secondary side of the transformer Tr1. A third terminal of the primary side of the transformer Tr1 is connected to the primary-side single-phase full-bridge circuit, and a third terminal of the secondary side of the transformer Tr1 is connected to the secondary-side single-phase full-bridge circuit. The first inductor L1 has an inductance greater than the second inductor L2, and the third inductor L3 has an inductance greater than the fourth inductor L4. When both the input voltage and the output voltage are high voltages, the first switching unit is configured to be connected to the first inductor L1 and the third inductor L3, and disconnected from the second inductor L2 and the fourth inductor L4, to adjust a total inductance of the inductor unit to a first inductance. When the input voltage is a high voltage and the output voltage is a low voltage, the first switching unit is configured to be connected to the first inductor L1 and the fourth inductor L4, and disconnected from the second inductor L2 and the third inductor L3, to adjust the total inductance of the inductor unit to a second inductance; or when the input voltage is a low voltage and the output voltage is a high voltage, the first switching unit is configured to be connected to the second inductor L2 and the third inductor L3, and disconnected from the first inductor L1 and the fourth inductor L4, to adjust the total inductance of the inductor unit to the second inductance. When both the input voltage and the output voltage are low voltages, the first switching unit is configured to be connected to the second inductor L2 and the fourth inductor L4, and disconnected from the first inductor L1 and the third inductor L3, to adjust the total inductance of the inductor unit to a third inductance. The first inductance is greater than the second inductance, and the second inductance is greater than the third inductance.

In specific implementation, the DC-blocking unit includes a first DC-blocking capacitor Cd1 and a second DC-blocking capacitor Cd2. The first switching unit includes a third switch S3 and a fourth switch S4. One terminal of the first DC-blocking capacitor Cd1 is connected to the source of the first switch transistor Q1 and the drain of the second switch transistor Q2, and the other terminal of the first DC-blocking capacitor Cd1 is connected to the first terminal of the third switch S3. The second terminal of the third switch S3 (e.g., terminal 1 of S3 in FIG. 2) is connected to the first terminal of the first inductor L1, and a third terminal of the third switch S3 (e.g., terminal 2 of S3 in FIG. 2) is connected to the first terminal of the second inductor L2. One terminal of the second DC-blocking capacitor Cd2 is connected to the source of the seventh switch transistor Q7 and the drain of the eighth switch transistor Q8, and the other terminal of the second DC-blocking capacitor Cd2 is connected to the third terminal of the secondary side of the transformer Tr1. The first terminal of the fourth switch S4 is connected to the source of the fifth switch transistor Q5 and the drain of the sixth switch transistor Q6, the second terminal of the fourth switch S4 (e.g., terminal 1 of S4 in FIG. 2) is connected to the first terminal of the third inductor L3, and a third terminal of the fourth switch S4 (e.g., terminal 2 of S4 in FIG. 2) is connected to the first terminal of the fourth inductor L4.

TABLE 1
Diagram of relationships between turns ratios and inductance of an
improved type a of the DAB circuit according to this
embodiment under different operating states

| | | Total inductance | Utilization |
|---|---|---|---|
| Operating | | during | rate |
| states | Turns ratio | actual operation | of inductors |
| High input voltage to high output voltage | (e + f):(i + j) | $L 1 + {( \frac{e + f}{i + j} )}^{2} * L 3$ | 50% |
| High input voltage to low output voltage | (e + f):i | $L 1 + {( \frac{e + f}{j} )}^{2} * L 4$ | 50% |
| Low input voltage to high output voltage | f:(i + j) | $L 2 + {( \frac{f}{i + j} )}^{2} * L 3$ | 50% |
| Low input voltage to low output voltage | f:j | $L 2 + {( \frac{f}{j} )}^{2} * L 4$ | 50% |

Specifically, as illustrated in table 1, the inductances under the four operating states may be switched by adjusting the inductances of the four inductors L1, L2, L3, and L4. By setting L1>L2 and L3>L4, the inductances under the operating state of high input voltage to high output voltage, high input voltage to low output voltage (or low input voltage to high output voltage), and low input voltage to low output voltage decrease successively, thereby achieving optimal inductance control under different operating states.

In this embodiment, the turns ratio of the primary-side of the transformer Tr1 is switched through the third switch S3. When the first terminal of the third switch S3 is connected to the second terminal of the third switch S3, the primary side of the transformer Tr1 is connected to the first inductor L1. When the first terminal of the third switch S3 is connected to the third terminal of the third switch S3, the primary side of the transformer Tr1 is connected to the second inductor L2. When the first terminal of the fourth switch S4 is connected to the second terminal of the fourth switch S4, the secondary side of the transformer Tr1 is connected to the third inductor L3. When the first terminal of the fourth switch S4 is connected to the third terminal of the fourth switch S4, the secondary side of the transformer Tr1 is connected to the fourth inductor L4. That is, L1 operates only when the primary side is under high voltage and low current, for example, high input voltage. L3 operates only when the secondary side is under high voltage and low current, for example, high output voltage. L2 operates only when the primary side is under low voltage and high current, for example, low input voltage. L4 operates only when the secondary side is under low voltage and high current, for example, low output voltage. In this way, optimal control tailored to different operating conditions is more easily achieved.

It may be seen that, in this embodiment, the inductors connected to the DAB circuit can be freely switched according to different voltage states, thereby controlling the total inductance of inductors in the DAB circuit. The optimal inductance can be adjusted as needed, offering high flexibility, thereby enabling the DAB circuit to maintain high electrical energy conversion efficiency under any operating condition.

### Embodiment 2

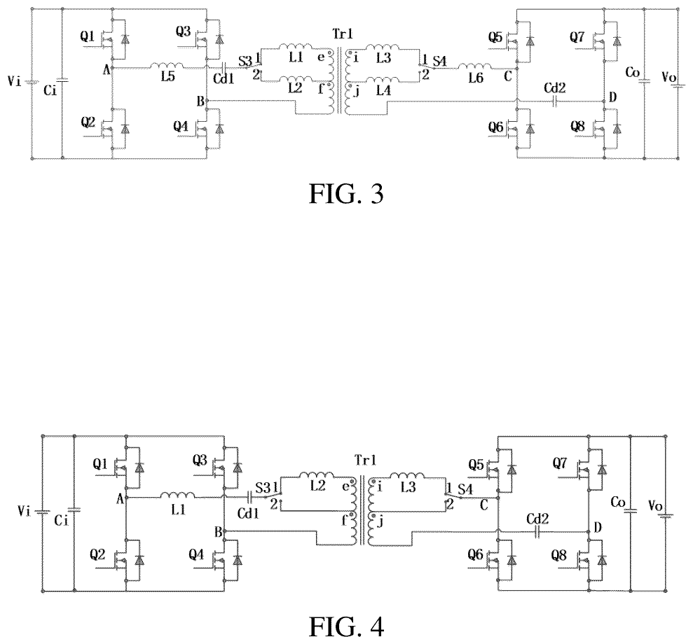

In a possible embodiment, as illustrated in FIG. 3, the inductor unit includes a first inductor L1, a second inductor L2, a third inductor L3, a fourth inductor L4, a fifth inductor L5, and a sixth inductor L6. A first terminal of the first inductor L1 is connected to the first switching unit, and a second terminal of the first inductor L1 is connected to a first terminal e of a primary side of the transformer Tr1. A first terminal of the second inductor L2 is connected to the first switching unit, and a second terminal of the second inductor L2 is connected to a second terminal f of the primary side of the transformer Tr1. A first terminal of the third inductor L3 is connected to the first switching unit, and a second terminal of the third inductor L3 is connected to a first terminal i of the secondary side of the transformer Tr1. A first terminal of the fourth inductor L4 is connected to the first switching unit, and a second terminal of the fourth inductor L4 is connected to a second terminal j of the secondary side of the transformer Tr1. A first terminal of the fifth inductor L5 is connected to the primary-side single-phase full-bridge circuit, and a second terminal of the fifth inductor L5 is connected to the DC-blocking unit. A first terminal of the sixth inductor L6 is connected to the first switching unit, and a second terminal of the sixth inductor L6 is connected to the secondary-side single-phase full-bridge circuit. A third terminal of the primary side of the transformer Tr1 is connected to the primary-side single-phase full-bridge circuit, and a third terminal of the secondary side of the transformer Tr1 is connected to the first switching unit. The first inductor L1 has an inductance greater than the second inductor L2, and the third inductor L3 has an inductance greater than the fourth inductor L4. When both the input voltage and the output voltage are high voltages, the first switching unit is configured to be connected to the first inductor L1, the third inductor L3, the fifth inductor L5, and the sixth inductor L6, and disconnected from the second inductor L2 and the fourth inductor L4, to adjust a total inductance of the inductor unit to a first inductance. When the input voltage is a high voltage and the output voltage is a low voltage, the first switching unit is configured to be connected to the first inductor L1, the fourth inductor L4, the fifth inductor L5, and the sixth inductor L6, and disconnected from the second inductor L2 and the third inductor L3, to adjust the total inductance of the inductor unit to a second inductance; or when the input voltage is a low voltage and the output voltage is a high voltage, the first switching unit is configured to be connected to the second inductor L2, the third inductor L3, the fifth inductor L5, and the sixth inductor L6, and disconnected from the first inductor L1 and the fourth inductor L4, to adjust the total inductance of the inductor unit to the second inductance. When both the input voltage and the output voltage are low voltages, the first switching unit is configured to be connected to the second inductor L2, the fourth inductor L4, the fifth inductor L5, and the sixth inductor L6, and disconnected from the first inductor L1 and the third inductor L3, to adjust the total inductance of the inductor unit to a third inductance. The first inductance is greater than the second inductance, and the second inductance is greater than the third inductance.

In specific implementation, the DC-blocking unit includes a first DC-blocking capacitor Cd1 and a second DC-blocking capacitor Cd2. The first switching unit includes a third switch S3 and a fourth switch S4. One terminal of the first DC-blocking capacitor Cd1 is connected to the second terminal of fifth inductor L5, and the other terminal of the first DC-blocking capacitor Cd1 is connected to the first terminal of the third switch S3. The second terminal of the third switch S3 (e.g., terminal 1 of S3 in FIG. 3) is connected to the first terminal of the first inductor L1, and a third terminal of the third switch S3 (e.g., terminal 2 of S3 in FIG. 3) is connected to the first terminal of the second inductor L2. One terminal of the second DC-blocking capacitor Cd2 is connected to the source of the seventh switch transistor Q7 and the drain of the eighth switch transistor Q8, and the other terminal of the second DC-blocking capacitor Cd2 is connected to the third terminal of the secondary side of the transformer Tr1. The first terminal of the fourth switch S4 is connected to the first terminal of the sixth inductor L6, the second terminal of the fourth switch S4 (e.g., terminal 1 of S4 in FIG. 3) is connected to the first terminal of the third inductor L3, and a third terminal of the fourth switch S4 (e.g., terminal 2 of S4 in FIG. 3) is connected to the first terminal of the fourth inductor L4.

TABLE 2
Diagram of relationships between turns ratios and inductance of the DAB
circuit according to this embodiment under various operating states

| | | Total inductance | Utilization |
|---|---|---|---|
| Operating | | during | rate |
| states | Turns ratio | actual operation | of inductors |
| High input voltage to high output voltage | (e + f):(i + j) | $L 5 + L 1 + {( \frac{e + f}{i + j} )}^{2} * ( L 3 + L 6 )$ | 67% |
| High input voltage to low output voltage | (e + f):i | $L 5 + L 1 + {( \frac{e + f}{j} )}^{2} * ( L 4 + L 6 )$ | 67% |
| Low input voltage to high output voltage | f:(i + j) | $L 5 + L 2 + {( \frac{f}{i + j} )}^{2} * ( L 3 + L 6 )$ | 67% |
| Low input voltage to low output voltage | f:j | $L 5 + L 2 + {( \frac{f}{j} )}^{2} * ( L 4 + L 6 )$ | 67% |

Specifically, as illustrated in table 2, under the current topology, four kinds of inductances can be obtained as listed in table 2. By designing the inductances of L1, L2, L3, L4, L5, and L6 to be different, four different total inductances can be obtained, respectively corresponding to four different operating states. By setting L1>L2 and L3>L4, the inductances under the operating state of high input voltage to high output voltage, high input voltage to low output voltage (or low input voltage to high output voltage), and low input voltage to low output voltage decrease successively. Due to a large quantity of the inductors, this solution offers the highest adjustment flexibility, thereby meeting the requirement for inductance variations under different operating states.

This embodiment is primarily suitable for different operating conditions and suitable for scenarios requiring high accuracy of inductance. Six inductors may be controlled separately to achieve accurate inductance control. L5 and L6 operate under all operating conditions, L1 and L3 operate only under high voltage and low current, and L2 and L4 operate only under low voltage and high current.

Furthermore, in this embodiment, the inductance of one or more inductors may be designed as 0 to achieve topology variations. For example, the inductances of L2 and L4 may be designed as 0, which is not specifically limited here.

It may be seen that, in this embodiment, multiple inductors are arranged and the circuit structure is optimized, such that the DAB circuit is suitable for different operating conditions and suitable for scenarios requiring high accuracy in inductance control, enhancing the circuit regulation capability, thereby enabling the DAB circuit to maintain high electrical energy conversion efficiency under any operating condition.

### Embodiment 3

In a possible embodiment, as illustrated in FIG. 4, the inductor unit includes a first inductor L1, a second inductor L2, and a third inductor L3. A first terminal of the first inductor L1 is connected to the primary-side single-phase full-bridge circuit, and a second terminal of the first inductor L1 is connected to the DC-blocking unit. A first terminal of the second inductor L2 is connected to the first switching unit, and a second terminal of the second inductor L2 is connected to a first terminal e of a primary side of the transformer Tr1. A first terminal of the third inductor L3 is connected to the first switching unit, and a second terminal of the third inductor L3 is connected to a first terminal i of the secondary side of the transformer Tr1. A second terminal f of the primary side of the transformer Tr1 is connected to the first switching unit, and a third terminal of the primary side of the transformer Tr1 is connected to the primary-side single-phase full-bridge circuit. A second terminal j of the secondary side of the transformer Tr1 is connected to the first switching unit, and a third terminal of the secondary side of the transformer Tr1 is connected to the secondary-side single-phase full-bridge circuit. When both the input voltage and the output voltage are high voltages, the first switching unit is configured to be connected to the first inductor L1, the second inductor L2, and the third inductor L3, to adjust a total inductance of the inductor unit to a first inductance. When the input voltage is a high voltage and the output voltage is a low voltage, the first switching unit is configured to be connected to the first inductor L1 and the second inductor L2 and disconnected from the third inductor L3, to adjust the total inductance of the inductor unit to a second inductance; or when the input voltage is a low voltage and the output voltage is a high voltage, the first switching unit is configured to be connected to the first inductor L1 and the third inductor L3 and disconnected from the second inductor L2, to adjust the total inductance of the inductor unit to the second inductance. When both the input voltage and the output voltage are low voltages, the first switching unit is configured to be connected to the first inductor L1 and disconnected from the second inductor L2 and the third inductor L3, to adjust the total inductance of the inductor unit to a third inductance. The first inductance is greater than the second inductance, and the second inductance is greater than the third inductance.

In specific implementation, the DC-blocking unit includes a first DC-blocking capacitor Cd1 and a second DC-blocking capacitor Cd2. The first switching unit includes a third switch S3 and a fourth switch S4. One terminal of the first DC-blocking capacitor Cd1 is connected to the second terminal of the first inductor L1, and the other terminal of the first DC-blocking capacitor Cd1 is connected to the first terminal of the third switch S3. The second terminal of the third switch S3 (e.g., terminal 1 of S3 in FIG. 4) is connected to the first terminal of the second inductor L2, and a third terminal of the third switch S3 (e.g., terminal 2 of S3 in FIG. 4) is connected to a second terminal f of the primary side of the transformer Tr1. One terminal of the second DC-blocking capacitor Cd2 is connected to the source of the seventh switch transistor Q7 and the drain of the eighth switch transistor Q8, and the other terminal of the second DC-blocking capacitor Cd2 is connected to the third terminal of the secondary side of the transformer Tr1. The first terminal of the fourth switch S4 is connected to the source of the fifth switch transistor Q5 and the drain of the sixth switch transistor Q6, the second terminal of the fourth switch S4 (e.g., terminal 1 of S4 in FIG. 4) is connected to the first terminal of the third inductor L3, and a third terminal of the fourth switch S4 (e.g., terminal 2 of S4 in FIG. 4) is connected to the second terminal j of the secondary side of the transformer Tr1.

TABLE 3
Diagram of relationships between turns ratios and inductance of an
improved type b of the DAB circuit according to this
embodiment under different operating states

| Operating | | Total inductance | Utilization rate |
|---|---|---|---|
| states | Turns ratio | during actual operation | of inductors |
| High input voltage to high output voltage | (e + f):(i + j) | $L 1 + L 2 + {( \frac{e + f}{i + j} )}^{2} * L 3$ | 100% |
| High input voltage to low output voltage | (e + f):i | L1 + L2 | 67% |
| Low input voltage to high output voltage | f:(i + j) | $L 1 + {( \frac{f}{i + j} )}^{2} * L 3$ | 67% |
| Low input voltage to low output voltage | f:j | L1 | 33% |

Specifically, as illustrated in table 3, after optimization, only three inductors are required in this embodiment, namely L1, L2, and L3. Four different inductances can still be obtained through the adjustment of the turns ratio, such that the inductances under the operating state of high input voltage to high output voltage, high input voltage to low output voltage (or low input voltage to high output voltage), and low input voltage to low output voltage decrease successively.

As can be seen from table 3, the solution in this embodiment offers higher power density and higher utilization rate of inductors. L1 operates under all operating conditions, and L2 and L3 operate only under high voltage and relatively small current.

It may be seen that, in this embodiment, the circuit structure is optimized and the quantity of the inductors is reduced, such that the inductance may be adjusted to be different, and the power density and the utilization rate of inductors are improved, thereby enabling the DAB circuit to maintain high electrical energy conversion efficiency under any operating condition.

### Embodiment 4

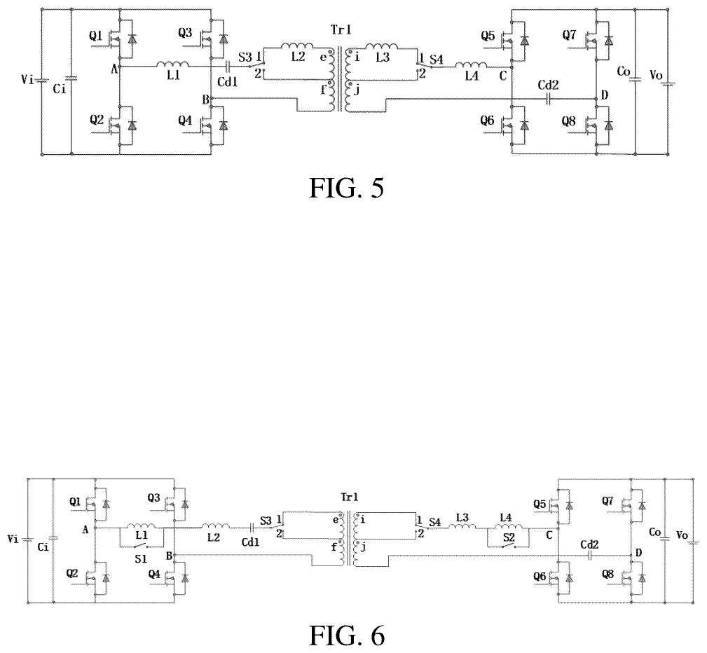

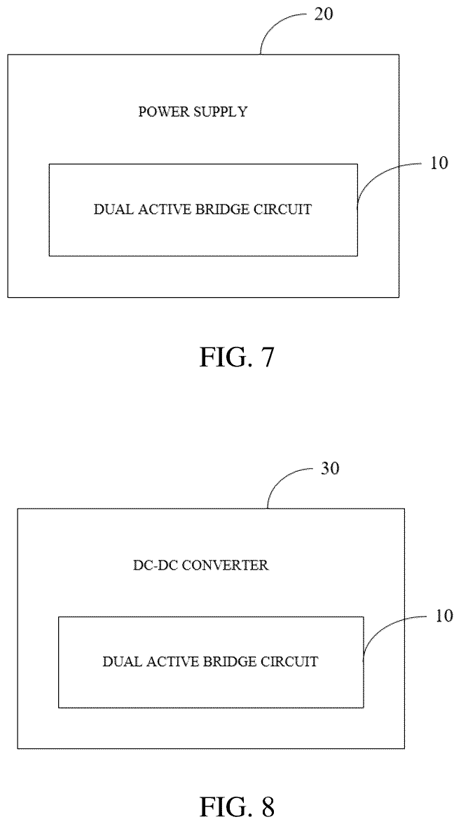

In a possible embodiment, as illustrated in FIG. 5, the inductor unit includes a first inductor L1, a second inductor L2, a third inductor L3, and a fourth inductor L4. A first terminal of the first inductor L1 is connected to the primary-side single-phase full-bridge circuit, and a second terminal of the first inductor L1 is connected to the DC-blocking unit. A first terminal of the second inductor L2 is connected to the first switching unit, and a second terminal of the second inductor L2 is connected to a first terminal e of a primary side of the transformer Tr1. A first terminal of the third inductor L3 is connected to the first switching unit, and a second terminal of the third inductor L3 is connected to a first terminal i of the secondary side of the transformer Tr1. A first terminal of the fourth inductor L4 is connected to the first switching unit, and a second terminal of the fourth inductor L4 is connected to the secondary-side single-phase full-bridge circuit. A second terminal f of the primary side of the transformer Tr1 is connected to the first switching unit, and a third terminal of the primary side of the transformer Tr1 is connected to the primary-side single-phase full-bridge circuit. A second terminal j of the secondary side of the transformer Tr1 is connected to the first switching unit, and a third terminal of the secondary side of the transformer Tr1 is connected to the secondary-side single-phase full-bridge circuit. When both the input voltage and the output voltage are high voltages, the first switching unit is configured to be connected to the first inductor L1, the second inductor L2, the third inductor L3, and the fourth inductor L4, to adjust a total inductance of the inductor unit to a first inductance. When the input voltage is a high voltage and the output voltage is a low voltage, the first switching unit is configured to be connected to the first inductor L1, the second inductor L2, and the fourth inductor L4, and disconnected from the third inductor L3, to adjust the total inductance of the inductor unit to a second inductance; or when the input voltage is a low voltage and the output voltage is a high voltage, the first switching unit is configured to be connected to the first inductor L1, the third inductor L3, and the fourth inductor L4, and disconnected from the second inductor L2, to adjust the total inductance of the inductor unit to the second inductance. When both the input voltage and the output voltage are low voltages, the first switching unit is configured to be connected to the first inductor L1 and the fourth inductor L4, and disconnected from the second inductor L2 and the third inductor L3, to adjust the total inductance of the inductor unit to a third inductance. The first inductance is greater than the second inductance, and the second inductance is greater than the third inductance.

In specific implementation, the DC-blocking unit includes a first DC-blocking capacitor Cd1 and a second DC-blocking capacitor Cd2. The first switching unit includes a third switch S3 and a fourth switch S4. One terminal of the first DC-blocking capacitor Cd1 is connected to the second terminal of first inductor L1, and the other terminal of the first DC-blocking capacitor Cd1 is connected to the first terminal of the third switch S3. The second terminal of the third switch S3 (e.g., terminal 1 of S3 in FIG. 5) is connected to the first terminal of the second inductor L2, and a third terminal of the third switch S3 (e.g., terminal 2 of S3 in FIG. 5) is connected to a second terminal f of the primary side of the transformer Tr1. One terminal of the second DC-blocking capacitor Cd2 is connected to the source of the seventh switch transistor Q7 and the drain of the eighth switch transistor Q8, and the other terminal of the second DC-blocking capacitor Cd2 is connected to the third terminal of the secondary side of the transformer Tr1. The first terminal of the fourth switch S4 is connected to the first terminal of the fourth inductor L4, the second terminal of the fourth switch S4 (e.g., terminal 1 of S4 in FIG. 5) is connected to the first terminal of the third inductor L3, and a third terminal of the fourth switch S4 (e.g., terminal 2 of S4 in FIG. 5) is connected to a second terminal j of the secondary side of the transformer Tr1.

TABLE 4
Diagram of relationships between turns ratios and inductance of the DAB
circuit according to this embodiment under various operating states

| | | Total inductance | Utilization |
|---|---|---|---|
| Operating | | during actual | rate |
| states | Turns ratio | operation | of inductors |
| High input voltage to high output voltage | (e + f):(i + j) | $L 1 + L 2 + {( \frac{e + f}{i + j} )}^{2} * ( L 3 + L 4 )$ | 100% |
| High input voltage to low output voltage | (e + f):i | $L 1 + L 2 + {( \frac{e + f}{j} )}^{2} * L 4$ | 75% |
| Low input voltage to high output voltage | f:(i + j) | $L 1 + {( \frac{f}{i + j} )}^{2} * ( L 3 + L 4 )$ | 75% |
| Low input voltage to low output voltage | f:j | $L 1 + {( \frac{f}{j} )}^{2} * L 4$ | 50% |

Specifically, as illustrated in table 4, in this embodiment, L1 and L4 operate under all operating conditions, and L2 and L3 operate only under high voltage. This solution features relatively high utilization rate of inductors. The expressions for inductances under operating states of high input voltage to low output voltage and low input voltage to high output voltage are relatively symmetrical, satisfying requirements for symmetrical input and output voltage ranges.

It may be seen that, in this embodiment, the circuit structure is optimized, such that the DAB circuit is more suitable for situations where the input and output voltage ranges are symmetrical. Also, the utilization rate of inductors is improved, thereby enabling the DAB circuit to maintain high electrical energy conversion efficiency under any operating condition.

### Embodiment 5

In a possible embodiment, as illustrated in FIG. 6, the transformer module further includes a second switching unit, the second switching unit includes a first switch S1 and a second switch S2, and the inductor unit includes a first inductor L1, a second inductor L2, a third inductor L3, and a fourth inductor L4. A first terminal of the first inductor L1 is connected to the primary-side single-phase full-bridge circuit and a first terminal of the first switch S1, and a second terminal of the first inductor L1 is connected to a first terminal of the second inductor L2 and a second terminal of the first switch S1. A second terminal of the second inductor L2 is connected to the DC-blocking unit, and the DC-blocking unit is connected to the first switching unit. A first terminal of the third inductor L3 is connected to the first switching unit, and a second terminal of the third inductor L3 is connected to a first terminal of the fourth inductor L4 and a first terminal of the second switch S2. A second terminal of the fourth inductor L4 is connected to the secondary-side single-phase full-bridge circuit and a second terminal of the second switch S2. A first terminal e and a second terminal of a primary side of the transformer Tr1 are both connected to the first switching unit, and a third terminal of the primary side of the transformer Tr1 is connected to the primary-side single-phase full-bridge circuit. A first terminal i and a second terminal of the secondary side of the transformer Tr1 are both connected to the first switching unit, a third terminal of the secondary side of the transformer is connected to the DC-blocking unit. When both the input voltage and the output voltage are high voltages, the first switching unit is configured to adjust the turns ratio of the transformer Tr1, and then turn off the first switch S1 and the second switch S2 to connect the first inductor L1, the second inductor L2, the third inductor L3, and the fourth inductor L4, to adjust a total inductance of the inductor unit to a first inductance. When the input voltage is a high voltage and the output voltage is a low voltage, the first switching unit is configured to adjust the turns ratio of the transformer Tr1, and turn off the first switch S1 and turn on the second switch S2 to connect the first inductor L1, the second inductor L2, and the third inductor L3, to adjust the total inductance of the inductor unit to a second inductance; or when the input voltage is a low voltage and the output voltage is a high voltage, the first switching unit is configured to adjust the turns ratio of the transformer Tr1, and turn on the first switch S1 and turn off the second switch S2 to connect the second inductor L2, the third inductor L3, and the fourth inductor L4, to adjust the total inductance of the inductor unit to the second inductance. When both the input voltage and the output voltage are low voltages, the first switching unit is configured to adjust the turns ratio of the transformer Tr1, and turn on the first switch S1 and the second switch S2 to connect the second inductor L2 and the third inductor L3, to adjust the total inductance of the inductor unit to a third inductance. The first inductance is greater than the second inductance, and the second inductance is greater than the third inductance.

In specific implementation, the DC-blocking unit includes a first DC-blocking capacitor Cd1 and a second DC-blocking capacitor Cd2. The first switching unit includes a third switch S3 and a fourth switch S4. One terminal of the first DC-blocking capacitor Cd1 is connected to the second terminal of second inductor L2, and the other terminal of the first DC-blocking capacitor Cd1 is connected to the first terminal of the third switch S3. The second terminal of the third switch S3 (e.g., terminal 1 of S3 in FIG. 6) is connected to a first terminal e of the primary side of the transformer Tr1, and a third terminal of the third switch S3 (e.g., terminal 2 of S3 in FIG. 6) is connected to a second terminal f of the primary side of the transformer Tr1. One terminal of the second DC-blocking capacitor Cd2 is connected to the source of the seventh switch transistor Q7 and the drain of the eighth switch transistor Q8, and the other terminal of the second DC-blocking capacitor Cd2 is connected to the third terminal of the secondary side of the transformer Tr1. The first terminal of the fourth switch S4 is connected to the first terminal of the third inductor L3, the second terminal of the fourth switch S4 (e.g., terminal 1 of S4 in FIG. 6) is connected to a first terminal i of the secondary side of the transformer Tr1, and a third terminal of the fourth switch S4 (e.g., terminal 2 of S4 in FIG. 6) is connected to a second terminal j of the secondary side of the transformer Tr1.

TABLE 5
Diagram of relationships between turns ratios and inductance of the DAB circuit
according to this embodiment under various operating states

| | | | (S2, S4) switch status, | |
|---|---|---|---|---|
| Operating | | Total inductance during | 1 represents turn-on, | Utilization rate |
| states | Turns ratio | actual operation | 0 represents tum-off | of inductors |
| High input voltage to high output voltage | (e + f):(i + j) | $L 1 + L 2 + {( \frac{e + f}{i + j} )}^{2} * ( L 3 + L 4 )$ | (0, 0) | 100% |
| High input voltage to low output voltage | (e + f):i | $L 1 + L 2 + {( \frac{e + f}{j} )}^{2} * L 3$ | (0, 1) | 75% |
| Low input voltage to high output voltage | f:(i + j) | $L 2 + {( \frac{f}{i + j} )}^{2} * ( L 3 + L 4 )$ | (1, 0) | 75% |
| Low input voltage to low output voltage | f:j | $L 2 + {( \frac{f}{j} )}^{2} * L 3$ | (1, 1) | 50% |

Specifically, as illustrated in table 5, in this embodiment, the inductance is switched using a method of connecting the inductors in parallel with the switches. As illustrated in FIG. 6, the first inductor L1 and the fourth inductor L4 are respectively connected in parallel with the first switch S1 and the second switch S2. When the first switch S1 and the second switch S2 are turned on, the first inductor L1 and the fourth inductor L4 do not operate in the DAB circuit. When the first switch S1 and the second switch S2 are turned off, the first inductor L1 and the fourth inductor L4 operate in the DAB circuit. In this way, the inductance may be switched under different operating conditions, and the control accuracy of the inductance may be improved.

It may be seen that, in this embodiment, decoupling between the inductance or the inductors and the windings of the transformer Tr1 can be achieved, allowing free control of the inductance in real-time and increasing the degree of freedom in inductance control, thereby enabling the DAB circuit to maintain high electrical energy conversion efficiency under any operating condition.

In an embodiment of the disclosure, a power supply 20 is provided. The power supply 20 includes the DAB circuit 10.

In an embodiment of the disclosure, a DC-DC converter 30 is provided. The DC-DC converter 30 includes the DAB circuit 10.

Although the disclosure has been disclosed above with reference to preferred embodiments thereof, it should be understood that the disclosure is presented by way of example only, and not limitation. Those of ordinary skill in the art can modify and vary the embodiments without departing from the spirit and scope of the disclosure, which includes any combinations of the above different functions and embodiment steps, and includes implementing ways of software and hardware, all falling within the scope of the disclosure.

What is claimed is:

1. A dual active bridge (DAB) circuit, comprising a primary-side direct current (DC) power supply, a primary-side single-phase full-bridge circuit, a transformer module, a secondary-side single-phase full-bridge circuit, and a secondary-side DC load connected in sequence;
wherein the transformer module comprises:
a transformer configured to perform voltage conversion on an input voltage input by the primary-side DC power supply and obtained through the primary-side single-phase full-bridge circuit, to obtain an output voltage;
a first switching unit configured to switch a turns ratio of the transformer according to the input voltage and the output voltage;
an inductor unit configured to provide a corresponding inductance when the first switching unit switches the turns ratio, to adjust power conversion efficiency of the primary-side single-phase full-bridge circuit and/or the secondary-side single-phase full-bridge circuit; and
a DC-blocking unit configured to isolate a DC voltage on a secondary side of the transformer and output an alternating current (AC) voltage on the secondary side of the transformer to the secondary-side single-phase full-bridge circuit;
wherein the inductor unit comprises a first inductor, a second inductor, a third inductor, and a fourth inductor; a first terminal of the first inductor is connected to the first switching unit, and a second terminal of the first inductor is connected to a first terminal of a primary side of the transformer; a first terminal of the second inductor is connected to the first switching unit, and a second terminal of the second inductor is connected to a second terminal of the primary side of the transformer; a first terminal of the third inductor is connected to the first switching unit, and a second terminal of the third inductor is connected to a first terminal of the secondary side of the transformer; a first terminal of the fourth inductor is connected to the first switching unit, and a second terminal of the fourth inductor is connected to a second terminal of the secondary side of the transformer; a third terminal of the primary side of the transformer is connected to the primary-side single-phase full-bridge circuit, and a third terminal of the secondary side of the transformer is connected to the secondary-side single-phase full-bridge circuit; wherein the first inductor has an inductance greater than the second inductor, and the third inductor has an inductance greater than the fourth inductor;
in response to both the input voltage and the output voltage being high voltages, the first switching unit is configured to be connected to the first inductor and the third inductor, and disconnected from the second inductor and the fourth inductor, to adjust a total inductance of the inductor unit to a first inductance;
in response to the input voltage being a high voltage and the output voltage being a low voltage, the first switching unit is configured to be connected to the first inductor and the fourth inductor, and disconnected from the second inductor and the third inductor, to adjust the total inductance of the inductor unit to a second inductance; or in response to the input voltage being a low voltage and the output voltage being a high voltage, the first switching unit is configured to be connected to the second inductor and the third inductor, and disconnected from the first inductor and the fourth inductor, to adjust the total inductance of the inductor unit to the second inductance; and
in response to both the input voltage and the output voltage being low voltages, the first switching unit is configured to be connected to the second inductor and the fourth inductor, and disconnected from the first inductor and the third inductor, to adjust the total inductance of the inductor unit to a third inductance;
wherein the first inductance>the second inductance>the third inductance.

2. The DAB circuit of claim 1, wherein the DC-blocking unit comprises a first DC-blocking capacitor and a second DC-blocking capacitor; one terminal of the first DC-blocking capacitor is connected to the first switching unit, and another terminal of the first DC-blocking capacitor is connected to the inductor unit or the primary-side single-phase full-bridge circuit; and one terminal of the second DC-blocking capacitor is connected to a third terminal of the secondary side of the transformer, and another terminal of the second DC-blocking capacitor is connected to the secondary-side single-phase full-bridge circuit.

3. The DAB circuit of claim 2, wherein the first switching unit comprises a third switch and a fourth switch; a first terminal of the third switch is connected to one terminal of the first DC-blocking capacitor, a second terminal of the third switch is connected to the inductor unit or the first terminal of the primary side of the transformer, and a third terminal of the fourth switch is connected to the inductor unit or the second terminal of the primary side of the transformer; a first terminal of the fourth switch is connected to the secondary-side single-phase full-bridge circuit or the inductor unit, a second terminal of the fourth switch is connected to the inductor unit or the first terminal of the secondary side of the transformer, and a third terminal of the fourth switch is connected to the inductor unit or the second terminal of the secondary side of the transformer.

4. A DAB circuit, comprising a primary-side DC power supply, a primary-side single-phase full-bridge circuit, a transformer module, a secondary-side single-phase full-bridge circuit, and a secondary-side DC load connected in sequence;
wherein the transformer module comprises:
a transformer configured to perform voltage conversion on an input voltage input by the primary-side DC power supply and obtained through the primary-side single-phase full-bridge circuit, to obtain an output voltage;
a first switching unit configured to switch a turns ratio of the transformer according to the input voltage and the output voltage;
an inductor unit configured to provide a corresponding inductance when the first switching unit switches the turns ratio, to adjust power conversion efficiency of the primary-side single-phase full-bridge circuit and/or the secondary-side single-phase full-bridge circuit; and
a DC-blocking unit configured to isolate a DC voltage on a secondary side of the transformer and output an AC voltage on the secondary side of the transformer to the secondary-side single-phase full-bridge circuit;
wherein the inductor unit comprises a first inductor, a second inductor, a third inductor, a fourth inductor, a fifth inductor, and a sixth inductor; a first terminal of the first inductor is connected to the first switching unit, and a second terminal of the first inductor is connected to a first terminal of a primary side of the transformer; a first terminal of the second inductor is connected to the first switching unit, and a second terminal of the second inductor is connected to a second terminal of the primary side of the transformer; a first terminal of the third inductor is connected to the first switching unit, and a second terminal of the third inductor is connected to a first terminal of the secondary side of the transformer; a first terminal of the fourth inductor is connected to the first switching unit, and a second terminal of the fourth inductor is connected to a second terminal of the secondary side of the transformer; a first terminal of the fifth inductor is connected to the primary-side single-phase full-bridge circuit, and a second terminal of the fifth inductor is connected to the DC-blocking unit; a first terminal of the sixth inductor is connected to the first switching unit, and a second terminal of the sixth inductor is connected to the secondary-side single-phase full-bridge circuit; a third terminal of the primary side of the transformer is connected to the primary-side single-phase full-bridge circuit, and a third terminal of the secondary side of the transformer is connected to the first switching unit;
wherein the first inductor has an inductance greater than the second inductor, and the third inductor has an inductance greater than the fourth inductor;
in response to both the input voltage and the output voltage being high voltages, the first switching unit is configured to be connected to the first inductor, the third inductor, the fifth inductor, and the sixth inductor, and disconnected from the second inductor and the fourth inductor, to adjust a total inductance of the inductor unit to a first inductance;
in response to the input voltage being a high voltage and the output voltage being a low voltage, the first switching unit is configured to be connected to the first inductor, the fourth inductor, the fifth inductor, and the sixth inductor, and disconnected from the second inductor and the third inductor, to adjust the total inductance of the inductor unit to a second inductance; or in response to the input voltage being a low voltage and the output voltage being a high voltage, the first switching unit is configured to be connected to the second inductor, the third inductor, the fifth inductor, and the sixth inductor, and disconnected from the first inductor and the fourth inductor, to adjust the total inductance of the inductor unit to the second inductance; and
in response to both the input voltage and the output voltage being low voltages, the first switching unit is configured to be connected to the second inductor, the fourth inductor, the fifth inductor, and the sixth inductor, and disconnected from the first inductor and the third inductor, to adjust the total inductance of the inductor unit to a third inductance;
wherein the first inductance>the second inductance>the third inductance.

5. The DAB circuit of claim 4, wherein the DC-blocking unit comprises a first DC-blocking capacitor and a second DC-blocking capacitor; one terminal of the first DC-blocking capacitor is connected to the first switching unit, and another terminal of the first DC-blocking capacitor is connected to the inductor unit or the primary-side single-phase full-bridge circuit; and one terminal of the second DC-blocking capacitor is connected to a third terminal of the secondary side of the transformer, and another terminal of the second DC-blocking capacitor is connected to the secondary-side single-phase full-bridge circuit.

6. The DAB circuit of claim 5, wherein the first switching unit comprises a third switch and a fourth switch; a first terminal of the third switch is connected to one terminal of the first DC-blocking capacitor, a second terminal of the third switch is connected to the inductor unit or the first terminal of the primary side of the transformer, and a third terminal of the fourth switch is connected to the inductor unit or the second terminal of the primary side of the transformer; a first terminal of the fourth switch is connected to the secondary-side single-phase full-bridge circuit or the inductor unit, a second terminal of the fourth switch is connected to the inductor unit or the first terminal of the secondary side of the transformer, and a third terminal of the fourth switch is connected to the inductor unit or the second terminal of the secondary side of the transformer.

7. A DAB circuit, comprising a primary-side DC power supply, a primary-side single-phase full-bridge circuit, a transformer module, a secondary-side single-phase full-bridge circuit, and a secondary-side DC load connected in sequence;
wherein the transformer module comprises:
a transformer configured to perform voltage conversion on an input voltage input by the primary-side DC power supply and obtained through the primary-side single-phase full-bridge circuit, to obtain an output voltage;
a first switching unit configured to switch a turns ratio of the transformer according to the input voltage and the output voltage;
an inductor unit configured to provide a corresponding inductance when the first switching unit switches the turns ratio, to adjust power conversion efficiency of the primary-side single-phase full-bridge circuit and/or the secondary-side single-phase full-bridge circuit; and
a DC-blocking unit configured to isolate a DC voltage on a secondary side of the transformer and output an AC voltage on the secondary side of the transformer to the secondary-side single-phase full-bridge circuit;
wherein the inductor unit comprises a first inductor, a second inductor, and a third inductor; a first terminal of the first inductor is connected to the primary-side single-phase full-bridge circuit, and a second terminal of the first inductor is connected to the DC-blocking unit; a first terminal of the second inductor is connected to the first switching unit, and a second terminal of the second inductor is connected to a first terminal of a primary side of the transformer; a first terminal of the third inductor is connected to the first switching unit, and a second terminal of the third inductor is connected to a first terminal of the secondary side of the transformer; a second terminal of the primary side of the transformer is connected to the first switching unit, and a third terminal of the primary side of the transformer is connected to the primary-side single-phase full-bridge circuit; a second terminal of the secondary side of the transformer is connected to the first switching unit, and a third terminal of the secondary side of the transformer is connected to the secondary-side single-phase full-bridge circuit;
in response to both the input voltage and the output voltage being high voltages, the first switching unit is configured to be connected to the first inductor, the second inductor, and the third inductor, to adjust a total inductance of the inductor unit to a first inductance;
in response to the input voltage being a high voltage and the output voltage being a low voltage, the first switching unit is configured to be connected to the first inductor and the second inductor and disconnected from the third inductor, to adjust the total inductance of the inductor unit to a second inductance; or in response to the input voltage being a low voltage and the output voltage being a high voltage, the first switching unit is configured to be connected to the first inductor and the third inductor and disconnected from the second inductor, to adjust the total inductance of the inductor unit to the second inductance; and
in response to both the input voltage and the output voltage being low voltages, the first switching unit is configured to be connected to the first inductor and disconnected from the second inductor and the third inductor, to adjust the total inductance of the inductor unit to a third inductance;
wherein the first inductance>the second inductance>the third inductance.

8. The DAB circuit of claim 7, wherein the DC-blocking unit comprises a first DC-blocking capacitor and a second DC-blocking capacitor; one terminal of the first DC-blocking capacitor is connected to the first switching unit, and another terminal of the first DC-blocking capacitor is connected to the inductor unit or the primary-side single-phase full-bridge circuit; and one terminal of the second DC-blocking capacitor is connected to a third terminal of the secondary side of the transformer, and another terminal of the second DC-blocking capacitor is connected to the secondary-side single-phase full-bridge circuit.

9. The DAB circuit of claim 8, wherein the first switching unit comprises a third switch and a fourth switch; a first terminal of the third switch is connected to one terminal of the first DC-blocking capacitor, a second terminal of the third switch is connected to the inductor unit or the first terminal of the primary side of the transformer, and a third terminal of the fourth switch is connected to the inductor unit or the second terminal of the primary side of the transformer; a first terminal of the fourth switch is connected to the secondary-side single-phase full-bridge circuit or the inductor unit, a second terminal of the fourth switch is connected to the inductor unit or the first terminal of the secondary side of the transformer, and a third terminal of the fourth switch is connected to the inductor unit or the second terminal of the secondary side of the transformer.

10. A power supply, comprising the DAB circuit of claim 1.

11. A power supply, comprising the DAB circuit of claim 4.

12. A power supply, comprising the DAB circuit of claim 7.

13. A DC-DC converter, comprising the DAB circuit of claim 1.

14. A DC-DC converter, comprising the DAB circuit of claim 4.

15. A DC-DC converter, comprising the DAB circuit of claim 7.
